(19) United States
(12) Patent Application Publication
(10) Pub. No.: US 2024/0354859 A1
(43) Pub. Date: Oct. 24, 2024

(54) INTEGRATED PORTFOLIO REBALANCING SYSTEM WITH AI-ASSISTED RECOMMENDATIONS AND SCALABLE FEATURES FOR INVESTMENT APPLICATIONS

(71) Applicant: Nowcasting.ai, Inc., Palo Alto, CA (US)

(72) Inventor: Damiàn Ariel SCAVO, Menlo Park, CA (US)

(21) Appl. No.: 18/638,518

(22) Filed: Apr. 17, 2024

Related U.S. Application Data
(60) Provisional application No. 63/463,661, filed on May 3, 2023.
(60) Provisional application No. 63/461,065, filed on Apr. 21, 2023.

(51) Int. Cl. G06Q 40/06

(52) U.S. Cl. CPC G06Q 40/06

(57) ABSTRACT

A method for performing investment portfolio adjustment that includes receiving, by a processor, user portfolio associated with a user, receiving, by the processor, a plurality of news data from various real-time information providers; analyzing and weighing, by the processor, the plurality of news data based on the user portfolio using an artificial intelligence (AI) model; and adjusting, by the processor, the user portfolio based on a weighed plurality of news data.

### CROSS-REFERENCE TO RELATED APPLICATIONS

This application claims priority under 35 USC § 119 (a) to U.S. Provisional Applications No. 63/461,065, filed on Apr. 21, 2023 and No. 63/463,661, filed on May 3, 2023, the contents of which are incorporated herein by reference in their entireties.

### BACKGROUND

### Field

The present invention relates to the field of investment applications, specifically to a system and method for rebalancing investment portfolios using artificial intelligence and machine learning algorithms.

### Related Art

Investors often face challenges in managing and rebalancing their investment portfolios, especially when considering market volatility, changing personal financial goals, and various asset classes. Existing portfolio management tools may not provide the level of customization, automation, or user-friendly features that are necessary for effective portfolio rebalancing. Thus, there is a need for an integrated system that simplifies the rebalancing process, offers personalized recommendations, and incorporates scalable features to adapt to future market and technology changes.

### SUMMARY

The present invention provides an integrated portfolio rebalancing system for investment applications, designed to optimize user experience, simplify portfolio management, and empower users to achieve their financial goals. The system incorporates current and potential future features that enhance user experience and adapt to changing market conditions and user preferences.

Accordingly, one aspect of the present invention is an integrated portfolio rebalancing system for investment applications. The system may include a dashboard integration displaying current portfolio balance and time since the last rebalance; and indicators prompting rebalancing actions.

Accordingly, one aspect of the present invention is a method for performing investment portfolio balancing. The method comprises receiving, by a processor, data associated with a user; receiving, by the processor, market condition information; generating, by the processor, a plurality of investment recommendations using a first artificial intelligence (AI) model with the data and the market condition information as input; ranking, by the processor, the plurality of investment recommendations based on coherence and accuracy using at least one second AI model; generating, by the processor, finalized investment recommendations based on ranked plurality of investment recommendations; and presenting, by the processor, the finalized investment recommendations to the user for selection, wherein selection of the finalized investment recommendations rebalances an investment portfolio of the user.

Accordingly, one aspect of the present invention is a system for performing investment portfolio balancing. The system comprises a database; a processor in communication with the database, the processor is configured to: receive data associated with a user from the database; receive market condition information; generate a plurality of investment recommendations using a first artificial intelligence (AI) model with the data and the market condition information as input; rank the plurality of investment recommendations based on coherence and accuracy using at least one second AI model; generate finalized investment recommendations based on ranked plurality of investment recommendations; and present the finalized investment recommendations to the user for selection, wherein selection of the finalized investment recommendations rebalances an investment portfolio of the user.

Accordingly, one aspect of the present invention is a method for performing investment portfolio adjustment. The method comprises receiving, by a processor, user portfolio associated with a user; receiving, by the processor, a plurality of news data from various real-time information providers; analyzing and weighing, by the processor, the plurality of news data based on the user portfolio using an artificial intelligence (AI) model; and adjusting, by the processor, the user portfolio based on a weighed plurality of news data.

Accordingly, one aspect of the present invention is a system for performing investment portfolio adjustment. The system comprises a database; and a processor in communication with the database, the processor is configured to: receive user portfolio associated with a user from the database; receive a plurality of news data from various real-time information providers; analyze and weigh the plurality of news data based on the user portfolio using an artificial intelligence (AI) model; and adjust the user portfolio based on a weighed plurality of news data.

The integrated portfolio rebalancing system may further include additional functionalities, such as incorporation of real-time data, such as credit card data, satellite data, or news, to further optimize investment strategies. In addition, the system may further use one or more generative AI systems to read, interpret, and weigh news signals from various real-time news providers in determining/adjust user portfolio positions.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example current portfolio prior to utilizing an integrated portfolio rebalancing system, in accordance with an example implementation.

FIG. 2 illustrates an example rebalanced portfolio recommendation after utilizing the integrated portfolio rebalancing system, in accordance with an example implementation.

FIG. 3 illustrates an example process flow 300 of user onboarding, in accordance with an example implementation.

FIG. 4 illustrates an example process flow 400 of a rebalancing process, in accordance with an example implementation.

FIG. 5 illustrates an example process flow 500 of an artificial intelligence (AI)-assisted recommendations process, in accordance with an example implementation.

FIG. 6 illustrates an example process flow 600 of a system settings and customization process, in accordance with an example implementation.

FIG. 7 illustrates an example process flow 700 of an additional/future features integration process, in accordance with an example implementation.

FIG. 8 illustrates an example alternate process flow for generating personalized investment strategies, in accordance with an example implementation.

FIG. 9 illustrates an example integrated portfolio rebalancing system 900, in accordance with an example implementation.

FIG. 10 illustrates an example process 1000 associated with the foregoing example implementations.

FIG. 11 illustrates an alternate process flow 1100 for news signal weighing and portfolio rebalancing, in accordance with an example implementation.

FIG. 12 illustrates example portfolio information generated through the integrated portfolio rebalancing system 900 using news signal weighing, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art of practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Example implementations relate to an integrated portfolio rebalancing system designed to optimize user experience and simplify the process of maintaining a balanced investment portfolio. The integrated portfolio rebalancing system may include features such as:
1. Dashboard Integration: The integrated portfolio rebalancing system includes a dashboard integration that displays the current portfolio balance, time since the last rebalance, and indicators prompting rebalancing actions.
2. Visual Representation: A visual representation module presents current and target allocations through graphical means, such as pie charts or bar graphs, to help users visualize the changes needed for rebalancing.
3. Rebalancing Settings: The integrated portfolio rebalancing system features a dedicated settings page where users can set their preferences for rebalancing, such as target allocations, rebalancing frequency, or threshold-based rebalancing. In some example implementations, integrated portfolio rebalancing system monitors a time period since last portfolio rebalancing. For the time period exceeding a predetermined rebalancing time threshold, a rebalancing alert/notification is generated and issued/sent to the user.
4. One-Click Rebalancing: The integrated portfolio rebalancing system incorporates a one-click rebalancing function, streamlining the initiation of the rebalancing process.
5. Notifications and Alerts: The integrated portfolio rebalancing system sends notifications and alerts to users when the portfolio deviates significantly from the target allocations due to differing returns, prompting users to review and consider rebalancing. In some example implementations, a deviation threshold (e.g., numerical value, percentage, etc.) can be set by a user/operator of the system, and rebalancing notification is issued whenever the threshold is not satisfied (e.g., below expectation, etc.).
6. Rebalancing History: A rebalancing history module tracks past rebalancing actions, changes, and performance impact, helping users understand the benefits of rebalancing over time.
7. Educational Content: The integrated portfolio rebalancing system offers in-app educational content, such as articles or videos, explaining the importance of rebalancing, the process, and best practices.
8. Walkthrough/Tutorial: The integrated portfolio rebalancing system provides a step-by-step walkthrough or tutorial for first-time users, guiding them through the rebalancing process, settings, and available features.
9. Personalized Recommendations: The integrated portfolio rebalancing system uses user data, machine learning algorithms, and generative artificial intelligence (AI) to generate personalized rebalancing suggestions/recommendations based on the user preferences, user settings, user's risk profile, investment goals, and market conditions. The generative AI models rank the recommendations for coherence and accuracy, with two or more models cross-verifying results before presenting proposals to users.
10. Manual Verification: The integrated portfolio rebalancing system allows for manual verification of the process, both live and deferred, ensuring the highest quality of recommendations.
11. Additional Features: The integrated portfolio rebalancing system is designed to incorporate additional features such as integration with voice assistance for hands-free rebalancing, social investing features that allow users to share and discuss their rebalancing strategies, predictive analytics for market trends, and a dynamic risk assessment module that continuously monitors market conditions and user preferences.

By incorporating these features, the integrated portfolio rebalancing system enhances user experience, simplifies portfolio management, and empowers users to achieve their financial goals while staying ahead of market changes.

Example implementations relate to an integrated portfolio rebalancing system that incorporates real-time data, such as credit card data, satellite data, or news, to further optimize portfolio rebalancing. The method leverages advanced Generative Artificial Intelligence (AI), to read, interpret, and weigh news signals from various real-time news providers and generate to adjust portfolio positions while taking the user's risk profile and other factors into consideration.

The integrated portfolio rebalancing system can incorporate real-time data, such as credit card data, satellite data, or news, to further optimize portfolio rebalancing. The system can for example, use one or more Generative AI systems to read, interpret, and weigh news signals from various real-time news providers. In some example implementations, weighing is performed through assignment of numerical scores to the views signals.

Based on the weighed news signals, the integrated portfolio rebalancing system can decide to adjust portfolio positions to capitalize on the news while considering the user's risk profile and other factors. The system can execute trades at market hours, Over-the-Counter (OTC), or during auctions and use various order types, including VWAP orders, market orders, and limit orders, to manage users' portfolios simultaneously. It aims to minimize market impact and randomize the average executed price for each user. The system can notify users of executed trades and the rationale behind them via push notifications, SMS, or email, using explanations generated by one or more language models.

Users can customize the functionality of the real-time news-driven portfolio adjustments through the app or web platform, choosing to leave the feature always active, opt-in/opt-out each time, or keep it always inactive to reduce the number of transactions.

Furthermore, associated services can be offered via API to power other Asset Management systems and can be integrated with any broker or dashboard used by Investment Advisors or hedge fund managers, enhancing the versatility and applicability of the system.

### Example of Outputs Via API:

```
[
  {
    “symbol”: “GOOGL”,
    “score”: “positive”,
    “price_impact”: 0.3,
    “explanation”: “Google's acquisition of Siemplify could strengthen its
cybersecurity offerings, potentially attracting more clients and increasing
revenues.”
  },
  {
    “symbol”: “PANW”,
    “score”: “negative”,
    “price_impact”: −0.2,
    “explanation”: “Palo Alto Networks, a competitor in the cybersecurity
space, might face increased competition from Google due to its acquisition
of Siemplify.”
  },
  {
    “symbol”: “FTNT”,
    “score”: “negative”,
    “price_impact”: −0.2,
    “explanation”: “Fortinet, another competitor in the cybersecurity
space, could see a negative impact from Google's strengthened position in
the market after the Siemplify acquisition.”
  },
  {
    “symbol”: “CHKP”,
    “score”: “negative”,
    “price_impact”: −0.2,
    “explanation”: “Check Point Software Technologies, also a
cybersecurity competitor, may face increased competition from Google as
it expands its offerings with the Siemplify acquisition.”
  },
  {
    “symbol”: “FFIV”,
    “score”: “unknown”,
    “price_impact”: 0.0,
    “explanation”: “F5 Networks, which provides application delivery
networking and security solutions, may be impacted by Google's
acquisition of Siemplify, but the extent of the impact is currently
unknown.”
  }
]
```

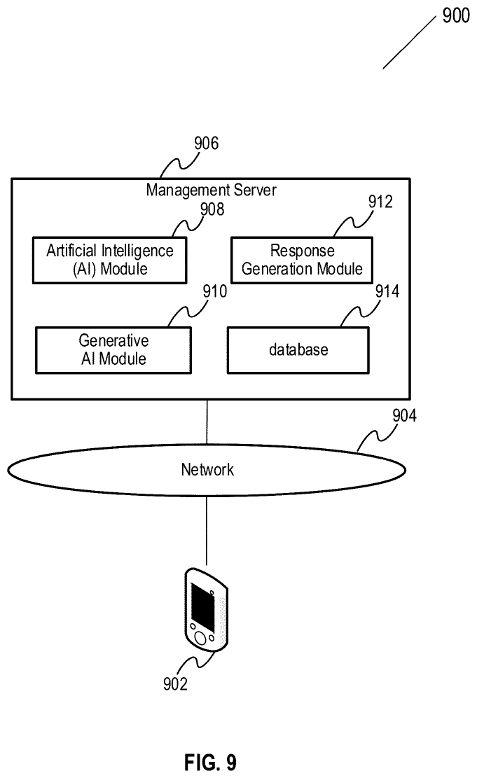

FIG. 9 illustrates an example integrated portfolio rebalancing system 900, in accordance with an example implementation. As illustrated in FIG. 9, the integrated portfolio rebalancing system 900 may include a user device 902 and a management server 906. The user device 902 communicates with the management server 906 through a network 904. Network 904 can be any network or combination of networks (e.g. internet, local area network, wide area network, telephonic network, cellular network, satellite network, etc.)

The user device 902 may receive input/request from a user for generation of investment strategies/portfolio management through a graphical user interface (GUI). Custom portfolio rebalancing recommendations may be generated based on the request entered by the user. In some example implementations, the user may enter information such as, but not limited to, user preferences, user settings, investment goals, risk levels/profile, etc., into the user device 902, which will then be used in recommendation formulation. The user interface may also display the rebalancing recommendations generated from the management server 906. Examples of user device 902 may include, but not limited to mobile devices (e.g. smartphones, devices in vehicle and other machine, tablets, notebooks, laptops, personal computers, etc.), and devices not designed for mobility (e.g. desktop computers, information kiosks, televisions, etc.)

The management server 906 receives the user input/request from the user device 902 through the network 904. The management server 906 may include components such as, but not limited to an artificial intelligence (AI) module 908, a generative AI module 910, a response generation module 912, and database 914. The AI module 908 generates AI-assisted rebalancing recommendations by using market conditions, user data, and one or more of user-entered information such as user preferences, user settings, investment goals, risk levels/profile of the user, etc., as input to an input layer of an AI model. A hidden layer of the AI model performs information extraction and evaluation on the input data and generates rebalancing recommendations. In some example implementations, the AI model generates a plurality of investment recommendations by evaluating the data and the market condition information based on at least one of user preferences, user settings, investment goals, risk levels/profile of the user.

An output layer of the AI model then outputs the rebalancing recommendations for further processing by the generative AI module 910. The AI model may include, but not limited to, recurrent neural network (RNN), deep RNN (DRNN), Q-learning network (QN), deep Q-learning network (DQN), etc. RNN may include long short-term memory (LSTM), etc. In some example implementations, the AI model is a large multimodal language model that works with different types of input data, such as text, images, audio, video, etc.

The generative AI module 910 then ranks the recommendations generated by the AI module 908. The ranked results are then cross-verified with one or more AI models using the AI module 908. In some example implementations, a separate AI module utilizing an independent AI model or generative AI model may be used for performing the cross-verification process.

The generative AI module 910 may utilize any one or combination of a variety of different models in ranking the generated recommendations, including but not limited to generative adversarial networks (GANs), variational auto-encoders (VAEs), auto-regressive models, transformers, etc. In some example implementations, an input layer of the one or more models of the generative AI module 910 receives the recommendations/extracted information from the AI module 908. A hidden layer of the one or more models of the generative AI module 910 then performs recommendation ranking, and the ranked recommendations are then output from an output layer. The AI modules are iteratively trained using historical data as training input and training parameters are adjusted to generate optimal results. In some example implementations, the generative AI module 910 ranks the generated recommendations and then outputs a predetermined number N of top responses for further processing. In some example implementations, selection of the N top responses is performed by scoring (e.g., based on accuracy, relevance, etc.) the responses and selecting the predetermined number N of top responses based on the scores.

The response generation module 912 generates finalized portfolio recommendations as proposals to the user and the proposals are displayed on user device 902. In some example implementations, distributed computing may be performed to generate portfolio recommendations at user devices 902. Specifically, a number of user devices 902 may be utilized to perform distributed computing when management server 906's resources are exhausted causing it to be overloaded. The number of user devices 902 may be used to generate portfolio recommendations locally when AI and/or generative AI is installed or accessed, and providing the generated portfolio recommendations to the requesting user device 902. Permission of the user may be needed before the number of user devices 902 can access information pertaining to request for portfolio recommendations.

Database 914 stores information pertaining to various components of the management server 906, which may include information such as, but not limited to, exclusive datasets, real-time market data, user preferences, user settings, risk levels, and past and present user portfolio information, etc.

An example is provided below with the following as input to the integrated portfolio rebalancing system:

CURRENT USER PORTFOLIO

| | |
|---|---|
| AAPL - Apple, Inc. | 20% |
| AMZN - Amazon.com, Inc. | 12% |
| GOOGL - Alphabet Inc. (Class A shares) | 12% |
| LMT - Lockheed Martin Corporation | 5% |
| NFLX - Netflix Inc. | 4% |
| NVDA - NVIDIA Corporation | 7% |
| MSFT - Microsoft Corporation | 10% |
| MOO - VanEck Agribusiness ETF | 6% |
| CANE - Teucrium Sugar Fund | 9% |
| GOLD - Barrick Gold Corporation | 15% |

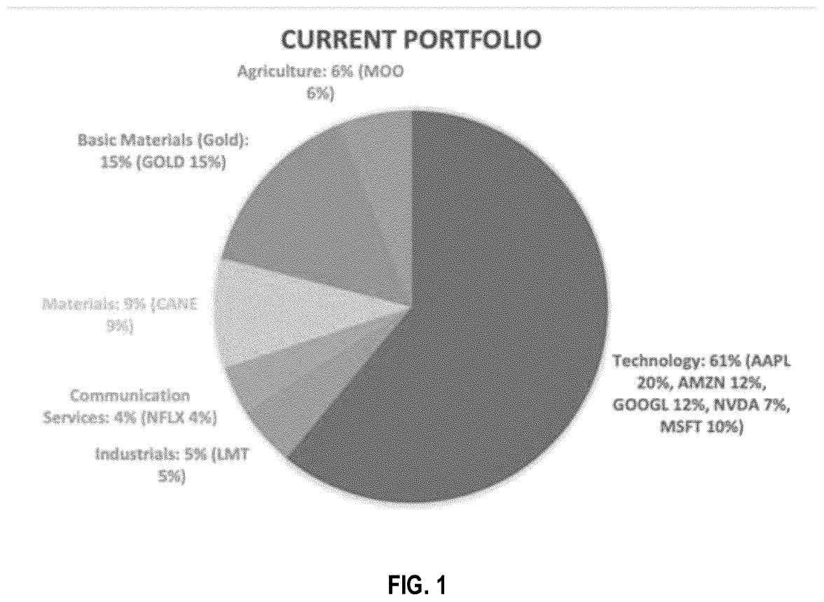

FIG. 1 illustrates an example current portfolio prior to utilizing an integrated portfolio rebalancing system, in accordance with an example implementation. The example provided above is shown in graphic form as illustrated in FIG. 1. As illustrated in FIG. 1, user's portfolio is shown in the form of a pie chart.

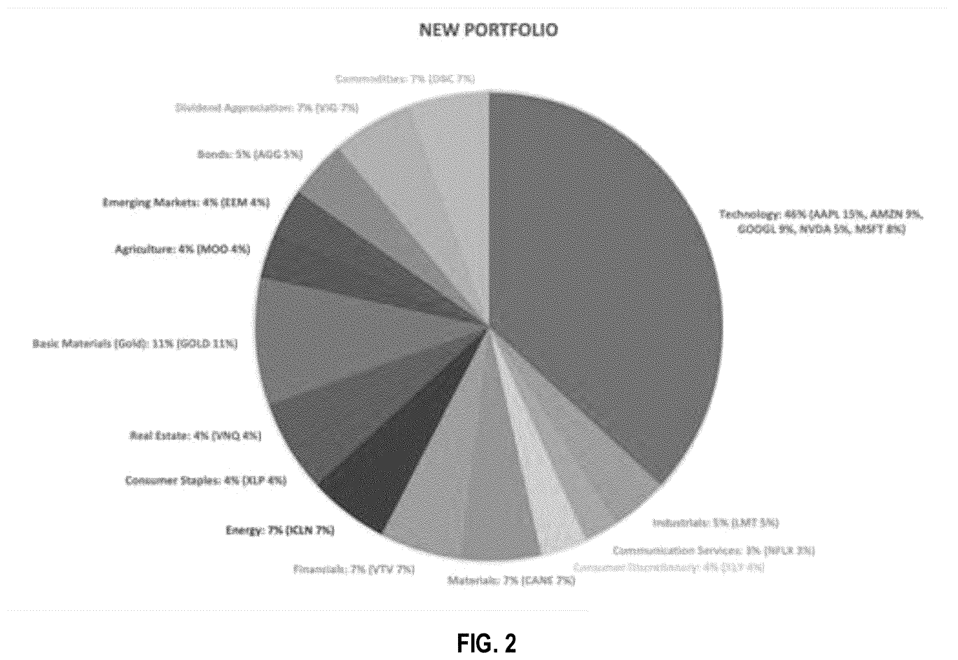

FIG. 2 illustrates an example rebalanced portfolio recommendation after utilizing the integrated portfolio rebalancing system, in accordance with an example implementation. As illustrated in FIG. 2, the portfolio is rebalanced to reduce concentration in certain areas while introducing additional diversification across other areas. The rebalanced portfolio from the integrated portfolio rebalancing system shows:

NEW RECOMMENDED PORTFOLIO:

| | |
|---|---|
| AAPL - Apple, Inc. | 15% |
| AMZN - Amazon.com Inc. | 9% |
| GOOGL - Alphabet Inc. (Class A shares) | 9% |
| LMT - Lockheed Martin Corporation | 5% |
| NFLX - Netflix Inc. | 3% |
| NVDA - NVIDIA Corporation | 5% |
| MSFT - Microsoft Corporation | 8% |
| MOO - VanEck Agribusiness ETF | 4% |
| CANE - Teucrium Sugar Fund | 7% |
| GOLD - Barrick Gold Corporation | 11% |
| EEM - iShares MSCI Emerging Markets ETF | 4% |
| AGG - iShares Core U.S. Aggregate Bond ETF | 5% |
| VIG - Vanguard Dividend Appreciation ETF | 7% |
| VTV - Vanguard Value ETF | 7% |
| XLP - Consumer Staples Select Sector SPDR Fund | 4% |
| DBC - Invesco DB Commodity Index Tracking Fund | 7% |
| VNQ - Vanguard Real Estate Index Fund ETF | 4% |
| ICLN - iShares Global Clean Energy ETF | 7% |
| XLY - Consumer Discretionary Select Sector SPDR Fund | 4% |

In some example implementations, the output portfolio is accompanied by a brief custom description. For example, “Assuming a moderate risk profile and taking into account current market conditions, the rebalanced portfolio could look like this”. A portfolio description may also be provided as part of the output from the integrated portfolio rebalancing system. For example, “This rebalanced portfolio reduces the concentration in individual technology stocks and introduces additional diversification across other sectors, asset classes, and geographies. It also allocates a portion to clean energy, which may be beneficial in the long term considering the global shift towards sustainable energy sources.”

The integrated portfolio rebalancing system incorporates categorization of each position by industry sector. In addition, the integrated portfolio rebalancing system also analyzes the proportions of each sector in the portfolio before and after the rebalancing process. By doing so, the integrated portfolio rebalancing system offers users a clear comparison of sector allocations, helping them understand the diversification changes introduced by the rebalancing process. Using the portfolio example provided earlier:

Original Portfolio:
Technology: 70% (AAPL 20%, AMZN 15%, GOOGL 15%, NFLX 10%,
NVDA 10%, MSFT 10%)
Basic Materials (Gold): 20% (GOLD 20%)
Other sectors: 0%
Rebalanced Portfolio:
Technology: 63% (AAPL 15%, AMZN 12%, GOOGL 12%, NFLX 7%,
NVDA 8%, MSFT 9%)
Basic Materials (Gold): 13% (GOLD 13%)
Consumer Staples: 4% (XLP 4%)
Real Estate: 4% (VNQ 4%)
Clean Energy: 6% (ICLN 6%)
Emerging Markets: 4% (EEM 4%)
Bonds: 5% (AGG 5%)
Dividend Appreciation: 7% (VIG 7%)
Value: 7% (VTV 7%)

The integrated portfolio rebalancing system provides a clearer picture of the sector allocation changes introduced by the rebalancing process. This allows users to see how their investments are diversified across different sectors, helping them make informed decisions about their investment strategy.

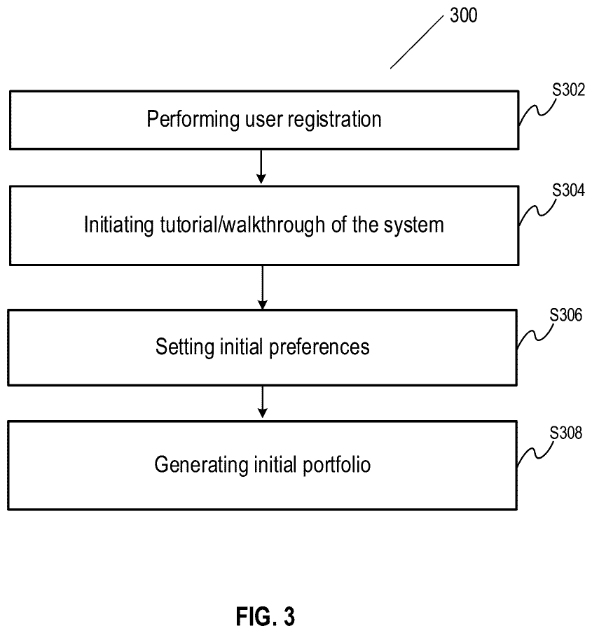

FIG. 3 illustrates an example process flow 300 of user onboarding, in accordance with an example implementation. FIG. 3 illustrates the process a new user goes through when starting to use the rebalancing system. The process begins at step S302, where user registration is performed. At step S304, tutorial or walkthrough of the system is retrieved from a database and initiated. At step S306, setting of initial preferences is performed. The process then proceeds to step S308, where an initial portfolio is generated. This process flow highlights the ease of getting started with the integrated portfolio rebalancing system.

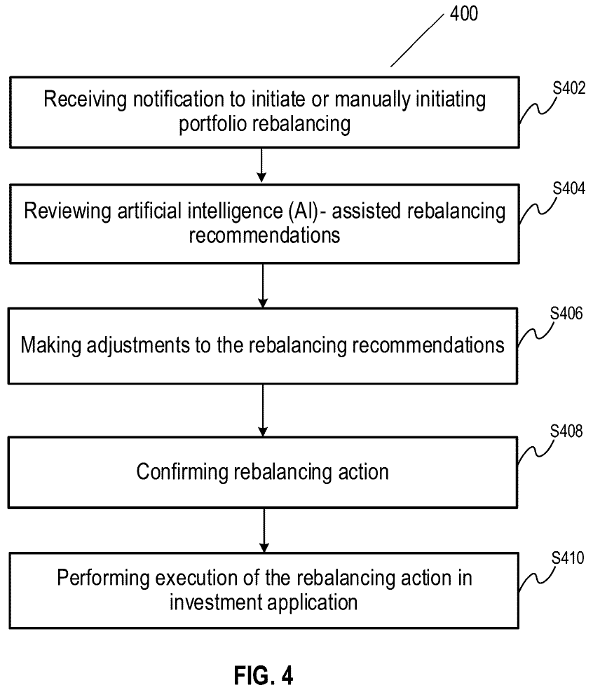

FIG. 4 illustrates an example process flow 400 of a rebalancing process, in accordance with an example implementation. FIG. 4 shows the steps involved in the rebalancing process. The process begins at step S402, where the user receives a notification to initiate or manually initiates portfolio rebalance. At step S404, the user reviews the artificial intelligence (AI)-assisted rebalancing recommendations. At step S406, adjustments are made to the rebalancing recommendations according to user's input. In some example implementations, the user may choose to perform any one of three actions of response/recommendation selection, response/recommendation modification, or additional recommendation request. The process then continues to step S408, where rebalancing action is confirmed. Finally, at step S410, execution of the rebalancing action is performed in the investment app/platform.

The strategies/recommendations ultimately accepted by the user will be saved for future investment purposes. In some example implementations, a summary and/or a detailed description may be generated for each strategy/recommendation, which the user can access at any time. The strategies/recommendations will then be provided to the platform/server, which will manage and treat the strategies/recommendations as a basket of securities for the user. In some example implementations, the system allow users to share the selected and/or modified strategies/recommendations with other users, who can copy the strategies/recommendations for their own investment execution and pay the user a commission/reward through the platform/server for strategy/recommendation sharing. The commission/rewards may take the form of cash back, discount codes, access to a locked functionality of the platform/server, lottery tickets, direct money back on a debit card or via a peer-to-peer mobile application, gift card, etc. In some example implementations, points are earned instead of or in conjunction with the commission/rewards. The amount of commission/rewards or points received by a sharing user may change based on the amount of capital contributed by other users to the shared strategies.

The system then assigns an ID to each strategy/recommendation, saves the strategies/recommendations with the requested modifications, verifies the availability of resources (e.g., to invest in the strategies), and allocate the user-specified capital to the chosen strategies/recommendations. The user can manage and view all generated strategies/recommendations, modify and delete them using various user interfaces. Once the user chooses/selects the desired strategies/recommendations, the platform/server will connect them to its database to generate all related data, including past performance charts at various maturities (e.g., 5 days, 1 month, 6 months, 1 year, etc.) and the Greeks for risk measurement at various maturities. The Greeks are variables used in assessing risk in the options market and include the four words-delta, gamma, theta, and vega. Each of the four Greek words represents a degree of risk.

In some example implementations, if the user has included, in his or her user settings, a default setting to immediately execute an order based on the chosen strategy/recommendation, then the order will be submitted as soon as the user confirms the recommendation or makes the selection (e.g., single user selection/action on the user device 902, etc.) without delay. Once the selection is made, the order can then be placed without further user input or review. In alternate example implementations, the order may be executed across a time period, such as the business day. According to one example implementation, a user may include in his or her user preferences, a default setting to make a purchase for a prescribed amount, such as $1 million, at even intervals over the course of the day.

Optionally, the default setting may allow the user to adjust the proportion of orders over the course of the day to be at uneven intervals; for example, as closely bunched at 20-minute intervals during a certain part of the day, spread out over longer intervals of one or two hours during another part of the day, etc. Also optionally, the default setting may allow the user to adjust the amount of each order to be even over the course of a day, such that the amount of investment is frontloaded towards the beginning of the day and gradually decreasing over the course of the day, backloaded to the end of the day and gradually increasing over the course of the day, matching to a profile curve defined by the user; matching to a prediction of an increase or decrease in the stock price at the next interval; or other user determined default setting.

Similarly, the user settings may provide an order limit in the default, such that if the price exceeds a price limit, the order is no longer executed for the rest of the day. Thus, according to one example implementation, if a user selects “yes” to purchase $1000 of a stock divided evenly over five hours, with a $200 order being placed every hour, and the stock price then exceeds the limit price during the third hour, then the fourth hour order of $200 will not be executed if the stock price continues to exceed the limit price. Similarly, at the fifth hour, if the stock price exceeds the limit price, that fifth hour order will not be placed.

With respect to the execution of the order, the user may provide, in the default settings, one or more default service providers, such as one or more brokers/robo-advisory platforms to automatically execute the order. Further, the user may provide one or more stock exchanges upon which to execute the order. The user may specify a percentage of an overall order to be placed with each of the one or more brokers/brokerages that is even, uneven, or proportionally divided automatically based on past performance relative to past strategies/responses.

As for the order size, the user default setting may provide for a predetermined order size, such as 100 shares, or a predetermined amount, such as $1000 worth of shares. Thus, the user need not specify the number of shares; the amount of the shares; which broker or brokers or stock exchanges to contact; the timing of the order placement and execution; the proportionality or evenness of the timing or amounts over a time, because those parameters are already determined based on the previously provided user settings. Accordingly, the user only needs to select “yes” or “no” (e.g., as appeared on the user device 902), to execute the order according to the default user settings as previously determined by the user.

In some example implementations, the user may receive one or more strategies/responses in the form of a push notification. In addition to a one-to-one relationship between the user action and the trade execution, the user may be provided with an option to execute all of the multiple push notifications that are provided together, with a single decision, by selecting an option such as “yes to all”. If such an option is selected, then all of the orders will be executed according to the predefined user preferences as explained above.

The foregoing example implementations may provide a push notification by modes known to those skilled in the art. For example, but not by way of limitation, the push notification may be provided by email, text message or SMS (short message service), chat via online social networking service, etc. Further, the push notification may be provided not just in a visual presentation, but alternatively or conjunctively as an audio message, such as by a speaker in a home device, such as AMAZON ALEXA or the like.

Further, the foregoing example implementations may provide the option of performing order execution during transport, such as to a driver receiving the signals via a telecommunications network including but not limited to a 5G network. Thus, the driver, by audio communication with a speaker and microphone or other input/output devices that would be understood by those skilled in the art, may execute, by a single voice command, the instruction to execute the order as explained above. Similarly, a passenger may also use the system. Thus, the example implementations may provide for hands-free order placement.

Additionally, while the example implementations may be implemented on a mobile communication device such as a smart phone, the example implementations are not limited thereto. For example, but not by way of limitation, the user settings may provide the user with control over the single action purchase modes, so as to require the user to join from an authenticated device, such as by requiring two factor authentication prior to accessing the strategies/responses, or the push notifications, or to provide a privacy preserving aspect, such that other form of authentication, such as login, biometric, second factor, or other aspect is required to receive the push notification. Similarly, in place of the user providing an audio response or selecting a specific option on a screen, the user may instead use gestures, signals, or other biometrics to indicate a decision.

For example, but not way of limitation, the user may determine that, in the user settings, if the first finger is placed on a fingerprint detector associated with the user device 902, then the user is indicating that the order should be executed in accordance with the strategy/recommendation provided; whereas, if a finger other than the first finger is placed on a fingerprint detector, then the user is indicating that the order should not be executed. Such an example implementation would allow the user to make his or her decision in the presence of other individuals who, although they may be able to hear or see the user interface, cannot understand whether the single action of the user is a decision to execute the order or not to execute the order. While the foregoing example refers to a fingerprint, other gestures or user signal as defined in the user settings may be employed. Similarly, a voice command other than “yes” or “no” may also be used, so as to prevent a third party from knowing what the user has decided to do simply based on hearing the audio response of the user. Thus, the privacy of the user is protected in circumstances where the user interface can be seen or heard by others.

In terms of hardware, the foregoing example implementations may be implemented in a client device such as a smart phone, laptop or the like. Further, and as also explained herein, the foregoing example implementations may be integrated with other devices, such as a device, a processor and memory of an automobile or other vehicle, or another device as would be understood by those skilled in the art. The foregoing user experiences may be provided by the user in a “user setting” aspect of an online application as parameters that are input by text entry, radio button, checkbox, slider or other visual manner of user input and user output as would be understood by those skilled in the art.

The example implementations described herein may be executed in the form of machine-readable executable instructions stored in a memory, which are configured to access the predefined user settings, which may be stored, such as in the database 914, either locally or remotely in the cloud for example, such that the user settings may be accessed by one or more devices as are authorized by the user to execute the instructions. Instructions may also be provided in the form of an online user application.

Before the foregoing example implementations are executed to provide the push notification, the user must enter the default user settings. When the online application is installed, a default series of settings may be provided based on a profile of information associated with the user. For example, but not by way of limitation, if the user self identifies their risk level as high, medium or low, then a default setting may be selected from a corresponding set of predefined profiles, based on aggregated information of other users in association with their risk profiles, to match the default setting of the user with an average default setting for other users having a similar risk profile. Factors other than the risk may be used to determine the default settings.

Additionally, the user may have multiple default settings, and different default settings may be applied depending on different user situations that may be automatically accessed by the online application. For example, but not by way of limitation, if the online application is aware that the available cash funds of a user in their bank accounts exceeds a prescribed level, the default settings may be set to one of the default settings in which the amounts, frequency, price limit or other aspect of the user settings are adjusted to account for an increased availability of investment funds, or an increased risk profile.

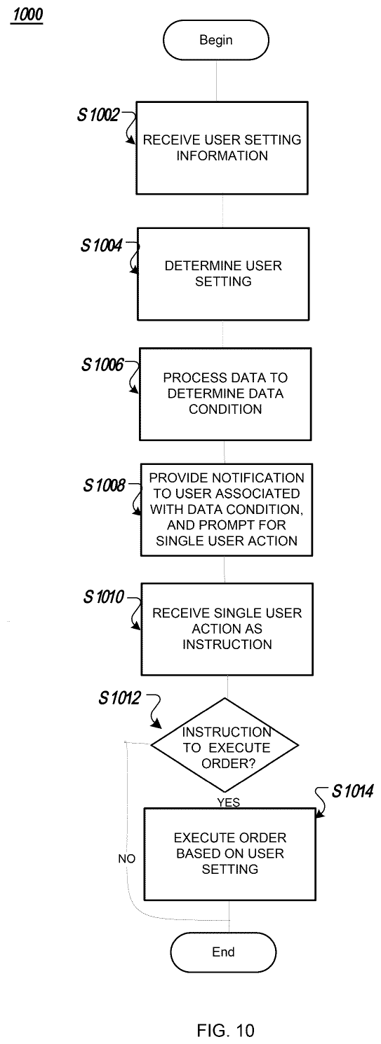

The integrated portfolio rebalancing system 900 integrates with third-party financial institutions to allow for seamless execution of investment strategies within the platform. FIG. 10 illustrates an example process 1000 associated with the foregoing example implementations. More specifically, the example process 1000 is directed to execution of an order based on a single user action, wherein the order is based on a received strategy/recommendation.

At step S1002, information that is associated with a user is received as user setting information. For example, but not by way of limitation, as explained above, information associated with a user's profile, such as preferences, risk information, financial information, demographic information or other information that is associated with the user is received through user input (e.g., through user device 902, online application, etc.). At step S1004, the user setting is determined. More specifically, the user setting information received from the user at step S1002 is assembled and stored, such as in the database 914, as a series of user preferences, thresholds, parameters, etc. Further, and as explained above, additional support tools or automated processes for determining a user setting, such as current time of a time period, such as end of quarter, end of year, payday, before or after major purchase event, or the like, may be taken into account. As an outcome of step S1004, the user setting is stored in a machine-readable form such that it can be accessed and applied in recommendation/strategy generation, so as to provide the necessary instructions or execution of the order associated with the recommendation/strategy without requiring any user input.

At step S1006, the example implementations perform processing of the data to determine a data condition (strategy/recommendation). At step S1008, the data condition is provided to the user in the form of a push notification, such as SMS, email or the like, as explained above. Further, the user is prompted for a single user action, such as “yes” or “no”. The user must determine only whether to execute an order based on the provided data condition. The information at step S1008 is provided to the user via a user interface on the user device 902, which as explained above may include, but is not limited to, visual and audio inputs.

At step S1010, a single user instruction is received. The single-user instruction is based on a single user action. For example, but not by way of limitation, the single-user action is the user selecting “yes” or “no”. This may be done, as explained above by visual or audio input to the user device 902, which may include a mobile phone, a laptop, etc., as also explained above. At step S1012, a determination is made as to the instruction associated with the single-user action. For example, but not by way of limitation, it is determined whether the single user action is to execute the order or not execute the order. If the operation at step S1012 determines that the single user action is an instruction to not execute the order, the process terminates.

On the other hand, if the single user action is determined to be an instruction to execute the order, then at step S1014, the order is executed based on the user setting that was determined at step S1004. More specifically, the user setting provides information that is, including but not limited to, whether the order is executed immediately or at a later time; whether the order is executed as a single transaction or a plurality of transactions; whether, if a plurality of transactions is requested; whether the timing and amount are evenly or unevenly distributed over the course of a day or other time period; and whether there are any price limits or other limits, or patterns in the case of an uneven distribution over the course of the day or other time period, and identity of one or more brokers or markets that constitute service providers, or other user settings as explained above. Thus, the order is executed based on a single user action, in association with the user settings.

Step S1014 may further include performance of an update to the user portfolio, so as to indicate that the order has been executed. Optionally, the user may be provided with a report via the communication or distribution channels explained above, to confirm that the order was executed, to provide an update of the portfolio, and/or to remind the user of any pending or open orders.

External data fetching according to the example implementations described herein may be performed by copying data from an external third party (e.g., vendor), and storing the data in a cloud storage container. The data fetching process may be managed by a scheduling server, and/or a serverless computer service that executes operations to manage the external data storage and the associated compute resources. Further, the extraction, transformation and loading of data as described herein may be executed by a batch management processor or service. Batch computing is the execution of a series of executable instructions (“jobs”) on one or more processors without manual intervention by a user, e.g., automatically. Input parameters may be pre-defined through scripts, command-line arguments, control files, or job control language. A batch job may be associated with completion of preceding jobs, or the availability of certain inputs. Thus, the sequencing and scheduling of multiple jobs is critical. Optionally, batch processing may not be performed with interactive processing. For example, the batch management processor or service may permit a user to create a job queue and job definition, and then to execute the job definition and review the results. According to an example implementation, a batch cluster includes 256 CPUs, and an ETL-dedicated server having 64 cores and 312 GB of RAM. The number of running instances may be 1. The foregoing ETL infrastructure may also be applied to the process of insight extraction. Further, an API is provided for data access. For example, but not by way of limitation, the REST API, which conforms to a REST style architecture and allows for interaction with RESTful resources, may be executed on a service. The service may include, but is not limited to, hardware such as 1 vCPU, 2 GB RAM, 10 GB SSD disk, and a minimum of two running instances. The API may be exposed to the Internet via an online application load balancer, which is elastic and permits configuration and routing of an incoming end-user to online applications based in the cloud, optionally pushing traffic across multiple targets in multiple availability zones. The caching layer may be provided by a fast content delivery network (CDN) service, which may securely deliver the data described herein with low latency and high transfer speeds. According to the example implementations, containers may be run without having to manage servers or clusters of instances, such that there is no need to provision, configure, or scale clusters on virtual machines to execute operations associated with containers.

The system connects the chosen strategies/recommendations to its database and generates relevant data such as past performance charts, Greeks, and other metrics at various maturities. The strategies/recommendations are then saved for future investment purposes, and short and long descriptions are generated for each strategy, which the user can access at any time.

The integrated portfolio rebalancing system 900 may support various asset classes, including stocks, exchange-traded funds (ETFs), futures, cryptocurrencies, blockchain-based assets, commodities, etc. The recommendation or generated responses may be associated with any one or more of asset classes of stocks, ETFs, futures, cryptocurrencies, blockchain-based assets, commodities, etc. In addition, the integrated portfolio rebalancing system 900 performs automatic monitoring and alert generation for significant market events or changes that may impact the user's investment strategies (e.g., events having market-wide impacts, news updates pertaining to current portfolio or company of interest, etc.).

In some example implementations, the integrated portfolio rebalancing system 900 provides a social-sharing feature that allows users to share their strategies/recommendations with others. The strategy/recommendation recipients may then copy the shared strategies/recommendations and issue a commission to the user for sharing the strategies/recommendations through the integrated portfolio rebalancing system 900. Receipt or issuance of commissions by users is controlled by the integrated portfolio rebalancing system 900.

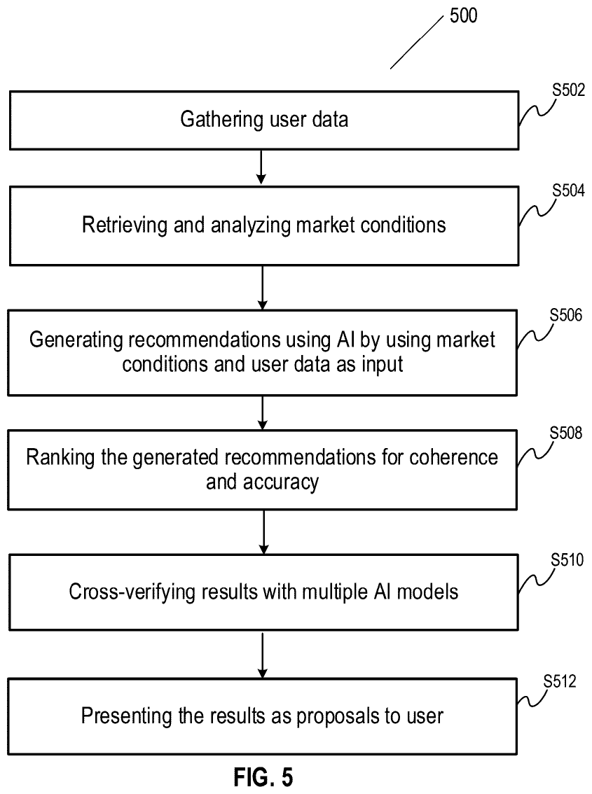

FIG. 5 illustrates an example process flow 500 of an artificial intelligence (AI)-assisted recommendations process, in accordance with an example implementation. FIG. 5 demonstrates how the system generates personalized recommendations using user data, machine learning algorithms, and generative AI. The process begins at step S502, where user data is gathered. At step S504, market conditions are retrieved and analyzed. At step S506, AI generated recommendations by using market conditions, user data, and at least one of user preferences, investment goals, or risk profile of the user as input. AI modeling may be based on, for example, a convolutional neural network (CNN), a fully connected (FC) neural network, a long short-term memory (LSTM), a recurrent neural network (RNN), etc. At step S508, the recommendations are ranked, using one or more generative AI models, for coherence and accuracy. At step S510, the results are cross-verified with one or more AI models. The process then continues to step S512, where the results are presented as proposals to the user.

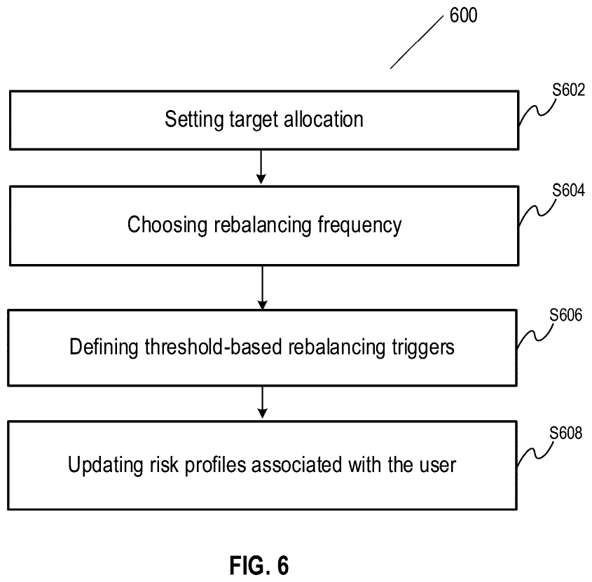

FIG. 6 illustrates an example process flow 600 of a system settings and customization process, in accordance with an example implementation. FIG. 6 outlines the process of customizing rebalancing settings. The process begins at step S602, where target allocations are set. At step S604, rebalancing frequency is chosen. At step S606, threshold-based rebalancing triggers are defined. At step S608, risk profiles are updated. The flowchart shows how users can tailor the system to meet their unique financial goals and preferences.

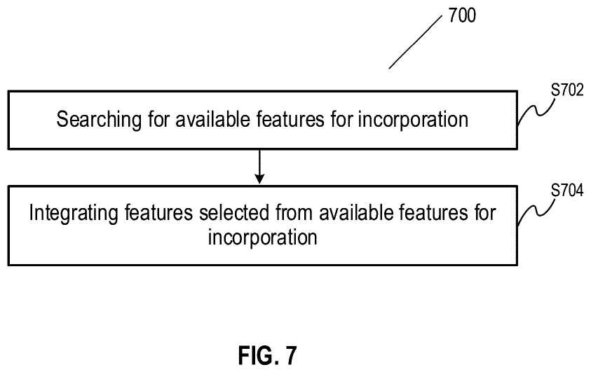

FIG. 7 illustrates an example process flow 700 of an additional/future features integration process, in accordance with an example implementation. FIG. 7 depicts the process of integrating additional/potential future features. The process begins at step S702, wherein available features are searched and identified from a database. At step S704, features selected from available features are integrated. The flowchart highlights the scalability and adaptability of the integrated portfolio rebalancing system as market conditions and technology evolve.

These five flowcharts help visualize the various processes and components of the integrated portfolio rebalancing system, showcasing the user-friendly nature and adaptability of the invention.

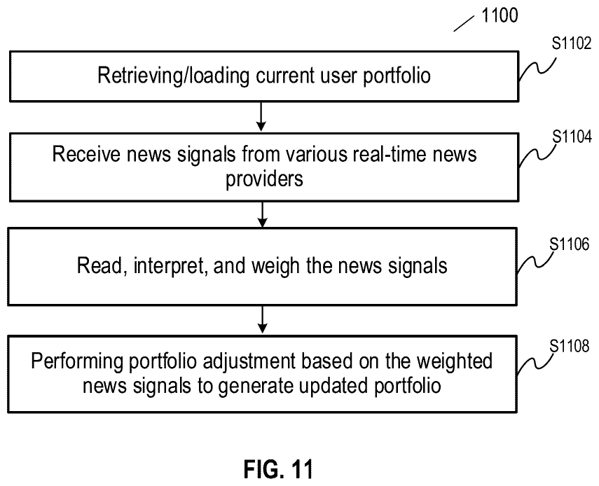

FIG. 11 illustrates an alternate process flow 1100 for news signal weighing and portfolio rebalancing, in accordance with an example implementation. Process flow 1100 is performed by the integrated portfolio rebalancing system 900. As illustrated in FIG. 11, the process begins at step 1102, where current user portfolio is retrieved/loaded. At step S1104, news signals from various real-time news providers are received. At step S1106, generative AI is used to read, interpret, and weigh the news signals from various real-time news providers. The news signals are received at an input layer of the generative AI model, and processed at a hidden layer of the generative AI model to assign weights to the new signals. Weights are assigned based on relevance to one or more of relevance to portfolio, trend mapping, etc. The assigned weights are then output from an output layer of the generative AI model.

In some example implementations, the generative AI model for performing weight assignment is stored in the generative AI module 910. At step S1108, portfolio adjustment is performed based on the weighed news signals to generate updated portfolio. Based on the weighed news signals, the integrated portfolio rebalancing system 900 adjusts portfolio positions to capitalize on the news while considering the user's risk profile and other factors. Specifically, the generative AI module 910 generates and outputs one or more portfolio suggestions/recommendations based on the weighed news signals.

In some example implementations, the one or more portfolio suggestions/recommendations are transmitted to the user device for the user to review. The user may perform one or more actions of response/recommendation selection, response/recommendation modification, or additional recommendation request following receipt of the portfolio suggestions/recommendations. After the user has completed the action selection process, a portfolio adjustment order is then placed with one or more default service providers, such as one or more brokers/robo-advisory platforms to automatically execute the adjustment, according to default settings as entered by the user. Further, the user may provide one or more stock exchanges upon which to execute the order. The user may specify a percentage of an overall order to be placed with each of the one or more brokers/brokerages that is even, uneven, or proportionally divided automatically based on past performance relative to past adjustments.

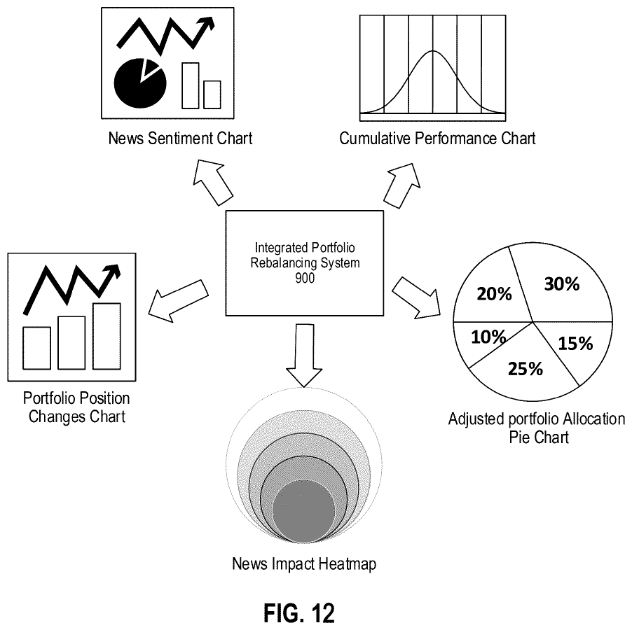

FIG. 12 illustrates example portfolio information generated through the integrated portfolio rebalancing system 900 using news signal weighing, in accordance with an example implementation. Through generation of personalized investment strategies through news signal weighing, the integrated portfolio rebalancing system 900 also provides additional portfolio information as output. Such information may include, but not limited to, news sentiment chart, portfolio position changes chart, cumulative performance chart, news impact heatmap, adjusted portfolio allocation pie chart, etc.

News Sentiment Chart: This chart displays the sentiment scores of the news articles analyzed by the generative AI system over time. Positive, neutral, and negative sentiment scores can be represented using different colors (e.g., green, gray, and red) to help users understand the overall market sentiment at a glance.

Portfolio Position Changes Chart: This chart illustrates the changes in portfolio positions resulting from real-time news-driven adjustments. Each adjustment can be represented as a vertical bar with varying heights, indicating the percentage change in the position. Users can easily compare the magnitude of changes across different assets and periods.

Cumulative Performance Chart: This chart shows the cumulative performance of the user's portfolio with and without the real-time news-driven adjustments. Two separate lines can represent the performance, allowing users to assess the value added by the news-driven adjustments over time.

News Impact Heatmap: A heatmap can be used to represent the impact of news articles on individual assets in the user's portfolio. Each cell in the heatmap corresponds to a specific asset and a specific time period, and its color represents the magnitude of the news-driven adjustment (positive, neutral, or negative). This visualization enables users to quickly identify the assets and time periods with the most significant news-driven changes.

Adjusted Portfolio Allocation Pie Chart: This chart displays the user's portfolio allocation before and after the real-time news-driven adjustments. Two separate pie charts can show the differences in allocation, helping users understand the distribution of their investments after the adjustments.

The foregoing example implementation may have various benefits and advantages. For example, use of the integrated portfolio rebalancing system enhances user experience, simplifies portfolio management, and empowers users to achieve their financial goals while staying ahead of market changes. Additionally, the integrated portfolio rebalancing system allows users to see how their investments are diversified across different sectors, helping them make informed decisions about their investment strategy. The innovative system allows users to manage their investments efficiently, share strategies with others, and optimize their portfolios based on their unique preferences and risk profiles. In addition, example implementations expand upon the integrated portfolio rebalancing system by introducing additional functionalities and innovative ideas to further enhance the user experience, increase personalization, and improve investment performance. By incorporating these new features, the system provides a more comprehensive and personalized investing experience.

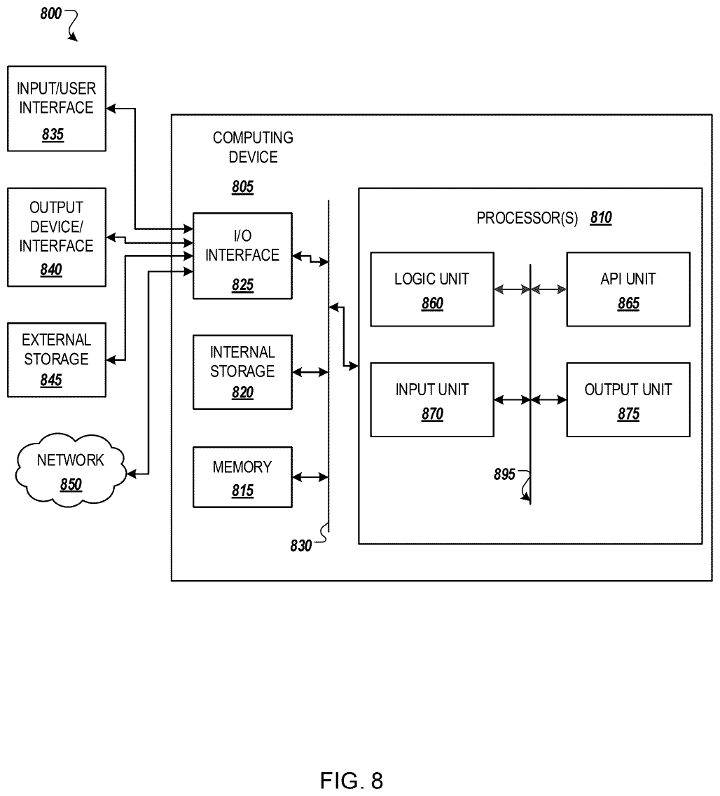

FIG. 8 illustrates an example computing environment with an example computer device suitable for use in some example implementations. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation. Computing environments of User device 102 and management server 106 may be represented by the computing environment of FIG. 4.

Computer device 805 can be communicatively coupled to input/user interface 835 and output device/interface 840. Either one or both of the input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configuration. Computer device 805 or any connected computer device can be functioning as, providing services of, or referred to as a server, client, thin server, general machine, special-purpose machine, or another label.

I/O interface 825 can include but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computer device 805 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, the input unit 870, the output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide an output based on the calculations described in example implementations.

Processor(s) 810 can be configured to receive data associated with a user from the database as illustrated in FIG. 5. The processor(s) 810 may also be configured to receive market condition information as illustrated in FIG. 5. The processor(s) 810 may also be configured to generate a plurality of investment recommendations using a first artificial intelligence (AI) model with the data and the market condition information as input as illustrated in FIG. 5. The processor(s) 810 may also be configured to rank the plurality of investment recommendations based on coherence and accuracy using at least one second AI model as illustrated in FIG. 5. The processor(s) 810 may also be configured to generate finalized investment recommendations based on ranked plurality of investment recommendations as illustrated in FIG. 5. The processor(s) 810 may also be configured to present the finalized investment recommendations to the user for selection as illustrated in FIG. 5. The processor(s) 810 may also be configured to execute a user request in response to a single user input to a user device to select the finalized investment recommendations as illustrated in FIG. 10.

The processor(s) 810 may also be configured to receive user portfolio associated with a user as illustrated in FIG. 11. The processor(s) 810 may also be configured to receive a plurality of news data from various real-time information providers as illustrated in FIG. 11. The processor(s) 810 may also be configured to analyze and weigh the plurality of news data based on the user portfolio using an artificial intelligence (AI) model as illustrated in FIG. 11. The processor(s) 810 may also be configured to adjust the user portfolio based on a weighed plurality of news data as illustrated in FIG. 11. The processor(s) 810 may also be configured to execute a user request in response to a single user input to a user device to select the finalized investment recommendations as illustrated in FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art, from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing investment portfolio balancing, the method comprising:
receiving, by a processor, data associated with a user;
receiving, by the processor, market condition information;
generating, by the processor, a plurality of investment recommendations using a first artificial intelligence (AI) model with the data and the market condition information as input;
ranking, by the processor, the plurality of investment recommendations based on coherence and accuracy using at least one second AI model;
generating, by the processor, finalized investment recommendations based on ranked plurality of investment recommendations; and
presenting, by the processor, the finalized investment recommendations to the user for selection,
wherein selection of the finalized investment recommendations rebalances an investment portfolio of the user.

2. The method of claim 1, wherein the at least one second AI model is a generative AI model.

3. The method of claim 1, wherein the processor is configured to generate the finalized investment recommendations by cross-verifying the ranked plurality of investment recommendations using at least one third AI model and selecting a predetermined number of top performing cross-verified investment recommendations as the finalized investment recommendations,
wherein the at least one third AI model is a generative AI model.

4. The method of claim 1, wherein the processor is configured to present the finalized investment recommendations to the user by graphically displaying the investment portfolio and a portfolio allocated based on the finalized investment recommendations on a user device,
wherein selection of the finalized investment recommendations is performed by the user on the user device.

5. The method of claim 1, further comprising:
monitoring, by the processor, a time period since last portfolio rebalancing; and
for the time period exceeding a predetermined rebalancing time threshold, generating, by the processor, a rebalancing alert on a user device.

6. The method of claim 1, further comprising:
monitoring, by the processor, a performance level of the investment portfolio; and
for the performance level deviating from a portfolio performance threshold, generating, by the processor, a rebalancing alert on a user device.

7. The method of claim 1, further comprising:
receiving, by the processor, at least one rebalance preference comprising one or more of target allocations, a rebalancing frequency, or at least one threshold-based rebalancing trigger.

8. The method of claim 1, further comprising:
executing, by the processor, a user request in response to a single user input to a user device to select the finalized investment recommendations,
wherein executing the user request comprises automatically submitting at least one order, in accordance with selected finalized investment recommendations without requiring further input from the user.

9. The method of claim 1, wherein the generating the plurality of investment recommendations comprises:
receiving, by an input layer of the first AI model, at least one of user preferences, investment goals, or risk profile of the user; and
generating, by the first AI model, the plurality of investment recommendations by evaluating the data and the market condition information based on the at least one of user preferences, investment goals, risk profile of the user.

10. A method for performing investment portfolio adjustment, the method comprising:
receiving, by a processor, user portfolio associated with a user;
receiving, by the processor, a plurality of news data from various real-time information providers;
analyzing and weighing, by the processor, the plurality of news data based on the user portfolio using an artificial intelligence (AI) model; and
adjusting, by the processor, the user portfolio based on a weighed plurality of news data.

11. The method of claim 10, wherein the AI model is a generative AI model.

12. The method of claim 10, wherein the processor is configured to adjust the user portfolio by:
generating, by the processor, one or more portfolio adjustment recommendations by the AI model; and
transmitting, by the processor, the one or more portfolio adjustment recommendations to a user device for the user to review and select.

13. The method of claim 12, further comprising:
executing, by the processor, a user request in response to a single user input to the user device to select the one or more portfolio adjustment recommendations,
wherein the executing the user request comprises automatically submitting at least one order, in accordance with selected one or more portfolio adjustment recommendations without requiring further input from the user.

14. The method of claim 13, wherein the select the one or more portfolio adjustment recommendations comprising performing, by the user, at least one of response selection, response modification, or additional response request in association with the one or more portfolio adjustment recommendations.

15. A system for performing investment portfolio adjustment, the system comprising:
a database; and
a processor in communication with the database, the processor is configured to:
receive user portfolio associated with a user from the database;
receive a plurality of news data from various real-time information providers;
analyze and weigh the plurality of news data based on the user portfolio using an artificial intelligence (AI) model; and
adjust the user portfolio based on a weighed plurality of news data.

16. The system of claim 15, wherein the AI model is a generative AI model.

17. The system of claim 15, wherein the processor is configured to adjust the user portfolio by:
generating one or more portfolio adjustment recommendations by the AI model; and
transmitting the one or more portfolio adjustment recommendations to a user device for the user to review and select.

18. The system of claim 17, wherein the processor is further configured to:
execute a user request in response to a single user input to the user device to select the one or more portfolio adjustment recommendations,
wherein the execute the user request comprises automatically submitting at least one order, in accordance with selected one or more portfolio adjustment recommendations without requiring further input from the user.

19. The system of claim 18, wherein the select the one or more portfolio adjustment recommendations comprising performing, by the user, at least one of response selection, response modification, or additional response request in association with the one or more portfolio adjustment recommendations.
